(19) United States
(12) Patent Application Publication
(10) Pub. No.: US 2007/0132132 A1
(43) Pub. Date: Jun. 14, 2007

(54) Component for a vehicle interior and a method of assembly

(75) Inventors: Marc Saelen, Zouaves (FR); Denis Dutouquet, Thumeries (FR)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/299,648

(22) Filed: Dec. 12, 2005

(51) Int. Cl. B29C 39/00; B32B 3/26; B32B 9/00

(52) U.S. Cl. 264/46.8; 428/304.4; 428/318.4

(57) ABSTRACT

A component for an interior of a vehicle and a method of assembly. The method includes the steps of inserting an added article into a vacuum mold, aligning a skin with the vacuum mold; and applying a vacuum force to the vacuum mold so that the skin is drawn to substantially envelope the added article to retain it with the skin. The skin and the added article cooperate to define a show surface that is substantially uninterrupted along a transition area between the skin and the added article.

### BACKGROUND

1. Field of the Invention

The present invention relates generally to a component for an interior of a vehicle. More particularly, the invention relates to a component for an instrument panel having a skin and an added article that cooperate with each other to define a substantially uninterrupted show surface.

2. Related Technology

Vehicle interior assemblies, such as instrument panel assemblies, are often formed of components having a skin covering that is exposed to the vehicle occupant. The exposed surface, which is typically referred to as a show surface or an A-surface is, therefore preferably designed to have an aesthetically pleasing appearance.

To enhance the aesthetic design of the component, the skin may include an added article that is exposed to the vehicle occupant. However, due to limitations in currently-known methods of assembling these added articles, currently-known designs include undesirable interruptions of a transition area between the added article and the skin. For example, the transition area may be interrupted by a tab or another sub-component that is configured to secure the added article in a particular position during assembly. Additionally, or alternatively, the transition area may be interrupted by a ridge extending away from the show surface or by a depression formed in the edge of the skin adjacent to the added article. As another example, the transition area may be interrupted by a gap between the skin and the added article. This interruption may degrade the aesthetic appearance of the component and/or cause premature part wear of one or both of the respective parts of the instrument panel. For example, a vehicle occupant may inadvertently snag a portion of clothing on the added article or an edge of the skin defining the gap, thereby causing high-stress forces acting on the skin and potentially tearing the component. Additionally, dirt and other contaminants may collect in any gap between the skin and the added article, thereby potentially weakening the bond between the surfaces of the respective subcomponents.

Therefore, it would be advantageous to provide a component for an interior of a vehicle and a method of assembly thereof, where the component includes a skin subcomponent and an added article with a substantially uninterrupted engagement between the two so that the respective subcomponents cooperate to define an aesthetically desirable show surface.

### SUMMARY

The present invention overcomes the drawbacks and limitations mentioned above by providing a method of assembly of a component for an interior of a vehicle that includes the steps of: inserting an added article into a vacuum mold, aligning a skin with the vacuum mold; and applying a vacuum force to the vacuum mold so that the skin substantially envelopes the added article and so that the skin and the added article cooperate to define a show surface that is substantially uninterrupted in the transition area between the skin and the added article.

For example, the vacuum force is preferably applied to the vacuum mold so that the show surface is interrupted by a gap less than or equal to 1.0 millimeters. Even more preferably, the gap is less than or equal to 0.1 millimeters and yet even more preferably, the gap is less than or equal to 0.05 millimeters. More preferably, the vacuum force is applied to the vacuum mold so that the show surface is completely uninterrupted by a gap.

In this aspect of the present invention, the added article may be completely enveloped by the skin or may be only partially enveloped by the skin. For example, the added article may be partially enveloped by the skin so that the added article is secured therewith.

The method of assembly may also include the step of providing an adhesive between the added article and the skin. While adhesion may be a natural property of the skin, the adhesive may be an additional layer that is coupled with the added article. Additionally, the skin may be heated before negative vacuum forming the skin to the vacuum mold. The heating operation may be used to activate the natural adhesive property of the skin and/or to increase the moldability of the skin before the vacuum force is applied. The temperature of the skin after the heating step can also activate the adhesive coupled with the added element thanks to the contact between both of them. Alternatively, the adhesive may be activated by a separate step that is independent of the above skin-heating step.

In another aspect of the invention, the method of assembly includes the step of securing the added article to a mold surface of the vacuum mold. For example, the added article may be releasably secured to the mold surface with a magnetic force, suction force, or other force.

In another aspect of the invention, the method of assembly includes the step of positioning the added article within a depression in the visible surface of the vacuum mold to secure the added article with respect to the visible surface of the vacuum mold. The depression preferably engages the A-surface of the added article in a mating engagement so that the added article is more securely positioned with respect to the vacuum mold and so as to minimize air pockets between the added article and the vacuum mold visible surface.

In another aspect of the invention, the method of assembly includes the step of providing a protective layer between the added article and the visible surface of the vacuum mold to protect at least one of the vacuum mold and the added article. Additionally, the protective layer may be a generally porous layer so that air is able to penetrate the protective layer and minimize any interruptions between the added article and the skin.

The method of assembly may also include the steps of removing the skin and the added article from the vacuum mold and coupling the components with a substrate and a foam layer to assemble a soft-feel component.

In another aspect of the invention, a method of assembling a component is provided, including the steps of providing an added article having an A-surface and a B-surface that cooperate to completely define a surface area of the added article, inserting the added article into a vacuum mold so that an A-surface of the added article engages a wall of the vacuum mold, and applying a vacuum force to the vacuum mold so that the skin substantially completely envelopes the B-surface of the added article. Additionally, the skin cooperates with the A-portion of the added article to define a substantially uninterrupted show surface.

The skin and the added article are preferably generally flush with each other along the transition area.

To minimize or eliminate an interruption along the transition area, the added article thickness is preferably less than or equal to 20 millimeters. The added article may be functional or decorative and may be made of any appropriate material, such as a generally rigid material, such as wood, metal, or plastic, or a generally non-rigid material, such as textile, skins, films, or leather.

To minimize air pockets between the added article and the skin in the vicinity of the show surface, a generally porous layer may be positioned between at least a portion of the B-surface of the added article and the skin. More specifically, the trapped air will be able to penetrate the porous layer rather than forming an air pocket near the show surface and creating or exaggerating an interruption in the transition area.

The above aspects of the present invention permit a wide variety of components to be assembled using a single mold assembly. This variety is beneficial because it permits the product to have several appearances or features with minimal or no retooling costs.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a cross-sectional view of a portion of a component for an interior of a vehicle embodying the principles of the present invention;

FIG. 2 is an enlarged cross-sectional view of the portion generally encircled by line 2-2 in FIG. 1;

FIG. 3 is a plan view of the added article and the skin shown in FIG. 2;

FIG. 4 is a plan view of an alternative design of the present invention similar to the view in FIG. 3;

FIG. 5 is enlarged cross-sectional view similar to the view shown in FIG. 2 of an alternative embodiment of the present invention;

FIG. 6 is a cross-sectional view of a vacuum mold for assembling a component embodying the principles of the present invention, shown with the added article placed on the visible mold surface before the vacuum force is applied to the vacuum mold;

FIG. 7 is a cross-sectional view of the vacuum mold shown in FIG. 6, shown after a vacuum force is applied to the vacuum mold;

FIG. 8 is a cross-sectional view of an injection mold for further assembling a component embodying the principles of the present invention;

FIG. 9 is a cross-sectional view of an alternative embodiment of the present invention whereby the added article is held in position by a magnetic force;

FIG. 10 is a cross-sectional view of another alternative embodiment of the present invention whereby the added article is held in position by a suction force;

FIG. 11 is a plan view of a component embodying the principles of the present invention; and

FIG. 12 is a plan view of an alternative embodiment of a component embodying the principles of the present invention;

FIG. 13 is a cross-sectional view of another alternative embodiment of the present invention whereby the added article protrudes away from the skin;

FIG. 14 is a cross-sectional view of yet another alternative embodiment of the present invention whereby an intermediate layer is located between the added article and the skin; and

FIG. 15 is a cross-sectional view of another alternative embodiment of the present invention whereby a protective layer is positioned between the added article and the mold.

### DETAILED DESCRIPTION

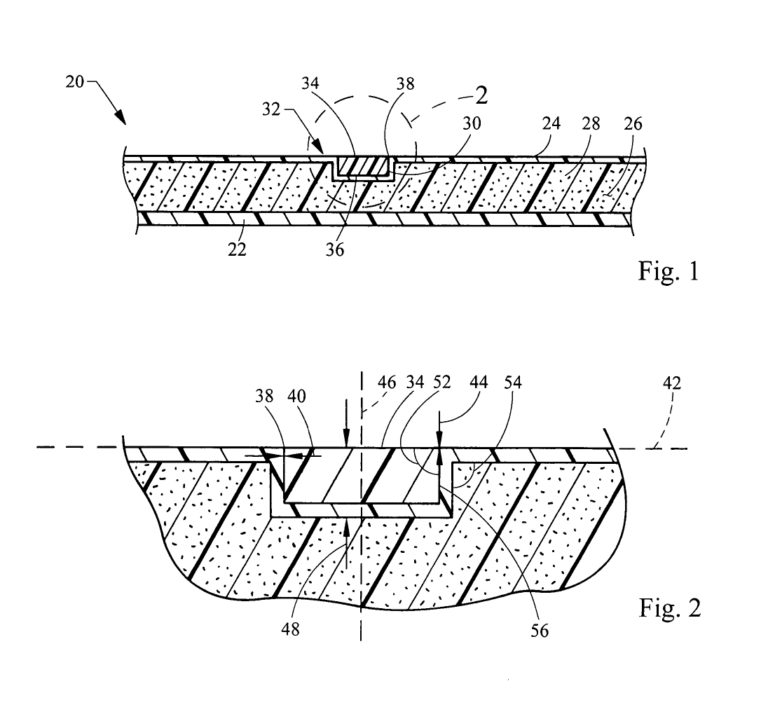

Referring now to the drawings, FIG. 1 shows a component, such as an instrument panel 20, for use in a vehicle interior assembly. The instrument panel 20 includes a substrate 22, a skin 24, and foam material 28 disposed within a cavity 26 between the skin 24 and the substrate 22, thereby providing the instrument panel 20 with a generally soft-touch feel.

As discussed herein, it may be desirable for aesthetic or for functional purposes to have an added article 30 located within the skin 24 and cooperating therewith to define a show surface 32 of the instrument panel 20. For example, the added article 30 may be a functional or decorative insert having a particular color or surface texture to give the instrument panel 20 a bi-colored or a bi-textured appearance. Additionally, or alternatively, the added article 30 may be indicia such as lettering or numbering to alert the vehicle occupant of the location of a particular vehicle component, such as an airbag; or to advertise the presence of a particular vehicle feature, such as four-wheel drive. Moreover, the added article 30 may be a functional component, such as a push-button switch or a trim piece for a HVAC duct, as is discussed in more detail below.

The added article 30 includes an A-surface 34 that cooperates with the skin 24 to define the show surface 32, which is the portion of the instrument panel 20 that is exposed and visible to the occupant of the vehicle interior compartment. Additionally, the added article 30 includes a B-surface 36 that is substantially enveloped by the skin 24 in a generally form-fitting engagement between the respective components 24, 30.

The added article may be completely enveloped by the skin or only partially enveloped by the skin. For example, the added article may be enveloped by only enough of the skin so that the added article is secured therewith. More specifically, in one design the skin only covers a portion of the B-surface 36, such as one or more side surface of the added article 30 and/or a portion of the back surface of the added article 30.

The A-surface 34 of the added article 30 and the skin 24 are preferably uninterrupted along a transition area 38 therebetween. More specifically, the transition area 38 is preferably substantially free from interruptions, such as: additional components located between the added article 30 and the skin 24, raised ridges, recessed grooves, or a gap between the respective components 24, 30.

Due to the absence of additional components, such as tabs or other components used to secure the added article in a desired position during assembly of the instrument panel 20, the skin 24 and the added article 30 are able to directly engage each other and form an aesthetically pleasing and secure connection. Similarly, due to the relatively uninterrupted show surface 32 in the transition area 38, the instrument panel 20 is generally protected from dirt and other contaminants that may become trapped within a groove or a gap formed in the show surface 32. Also, the instrument panel 20 is less likely to be ripped or torn in the transition area 38 than a component having a gap between the skin 24 and the added article 30 or a component having a raised ridge in the transition area 38.

To achieve the preceding, the skin 24 and the added article 30 are directly engaged with each other so that no gap exists therebetween. As used herein, no gap 40 is considered to be present if the separation of the skin 24 from the article at the transition area 38 is less than or equal to 0.05 millimeters. However, if a gap 40 larger than 0.05 millimeters does exist, it is preferably less than or equal to 1.0 millimeters. More preferably, the gap is less than or equal to 0.5 millimeters. The size of the gap 40 is generally measured along a direction that extends along a plane 42 of the show surface 32.

In addition to having a non-existent or minimally-sized gap 40, in one design the instrument panel 20 is also preferably generally flush in the transition area 38. In other words, the skin 24 and the added article 30 in the transition area 38 have a minimal or a non-existent off-set distance 44 that is measured in a direction 46 extending generally perpendicular to the show surface 32. The generally flush condition of the respective components 24, 30 creates a desirable appearance and a generally smooth feel along the transition area 38, as well as minimizing dirt and other contaminants that are able to accumulate on the show surface 32. However, it may be desirable for the added article 30 to be non-flush with the skin 24, as will be discussed in more detail below.

To minimize the size of or to eliminate the formation of the gap 40 and the off-set distance 44, the added article 30 itself preferably has a thickness 48 that is less than or equal to 20 millimeters, where the thickness 48 is measured in the perpendicular direction 46. Moreover, an effective angle 52 on the side cut of the added article 30 is preferably greater than or equal to 90 degrees so that an effective angle 54 of the skin 24 is less than or equal to 90 degrees. The effective angles 52, 54 of the added article 30 and the skin 24 are respectively measured between the surfaces defining the show surface 32 and the surfaces immediately away there from. For example, the effective angle 52 of the added article 30 is measured between the A-surface 34 and a side portion 56 of the added article 30. With such a side or undercut geometry, the added article 30 and the skin 24 can be mechanically locked together. Obviously, other side cut shapes (stepped, irregular, etc.) could be used as long as the aesthetics of the skin 24 are not negatively impacted.

For example, the added element may have an undercut geometry or may have edge portions protruding from the body of the added article 30. More specifically, the undercut geometry may be such that the added article 30 has a smaller width at a location near the show surface of the skin 24 and a greater width at a location further away from the show surface of the skin 24 to help secure the respective components 24, 30 together. As another example, the edge portions may be ridges that extend along the periphery of the added article 30, such as a generally horizontally-extending ridge (parallel with the plane 24 in FIG. 1) to more effectively secure the respective components 24, 30 together. As yet another example, the ridge may be generally vertically-extending so that the ridge acts as an anchor and provides a larger surface area of connection between the respective components 24, 30.

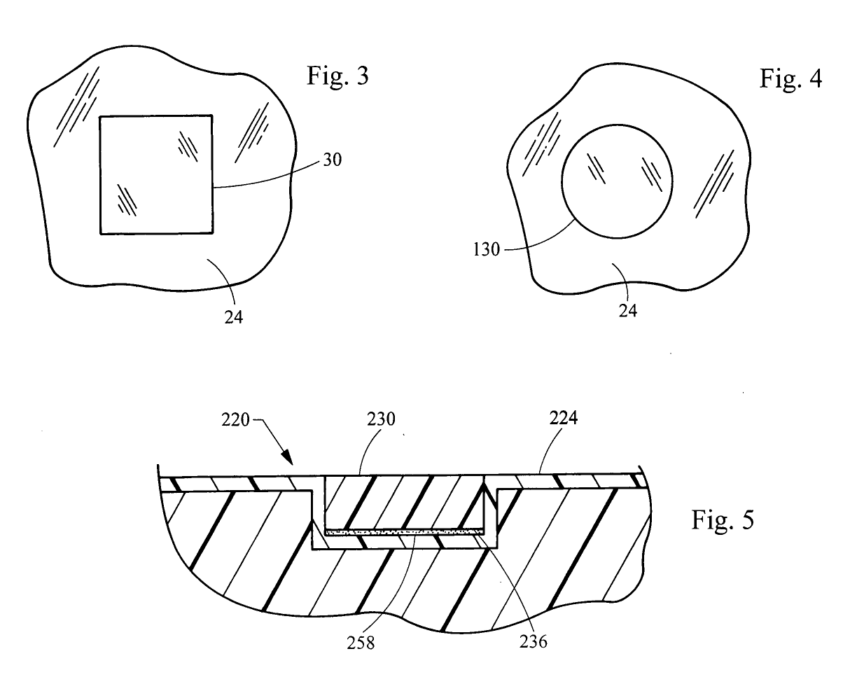

Referring to FIGS. 3, 4, 11, and 12, the outer perimeter of the added article 30, 130, 632, 732 may have any appropriate shape, such as a rectangular profile (FIG. 3), an arcuate profile (FIG. 4), or an irregular-shaped profile.

Referring now to FIG. 5, in an alternative embodiment, an adhesive 258 is positioned between skin 224 and the B-surface 236 of the added article 230 to improve the adhesion connection therebetween. For example, the adhesive 258 may be a natural quality of the skin 224 or it may be a separate layer that is inserted between the respective components 224, 230. In the case where the adhesive 258 is a natural property of the skin 224, it is preferably a property that is only caused to be active, or that is caused to become more effective, when the skin 224 is heated or otherwise treated, as is discussed in more detail below.

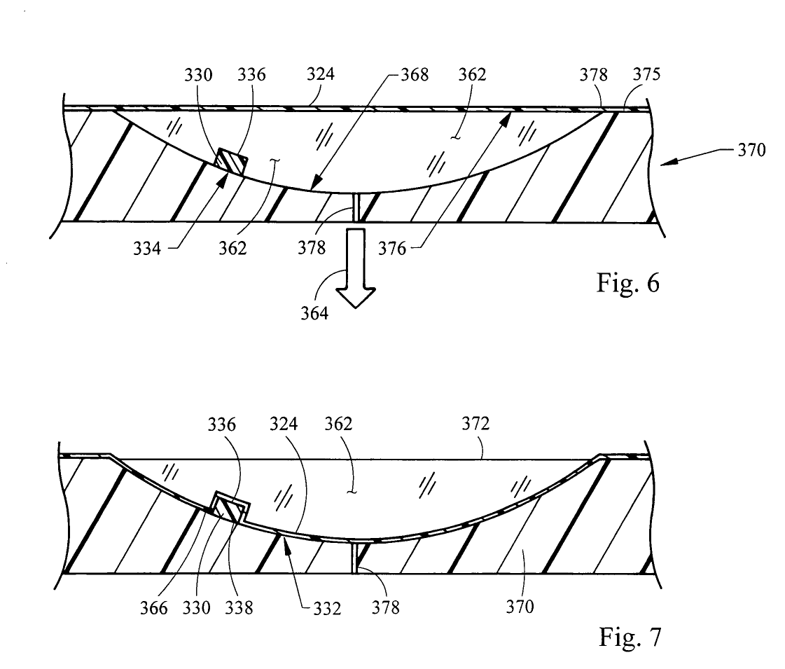

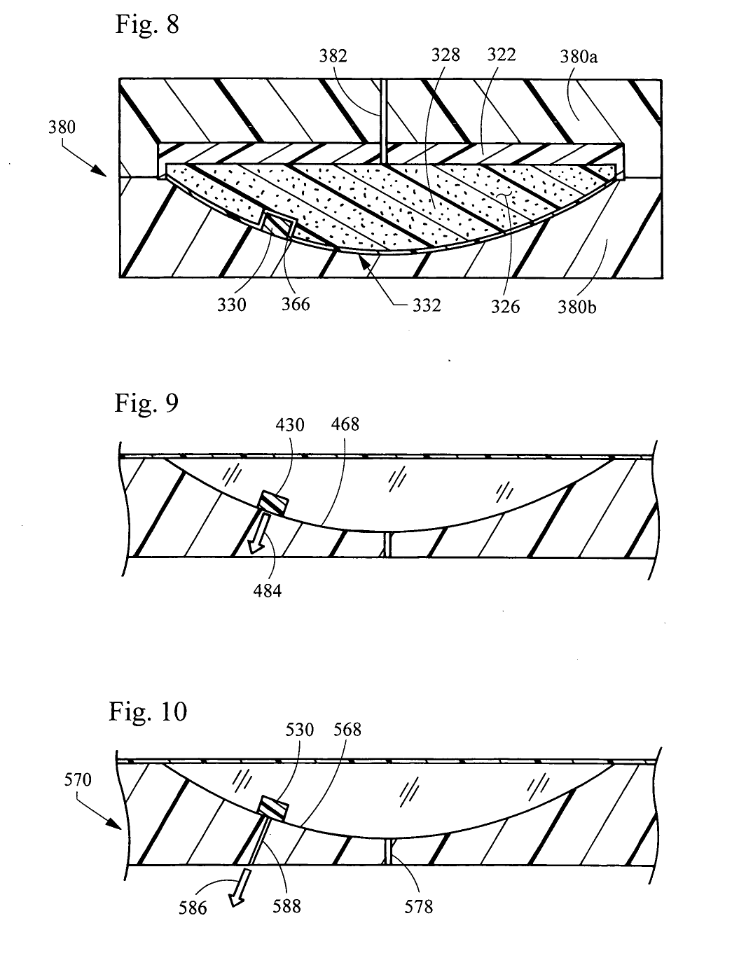

Referring to FIGS. 6-8, a method of assembling an instrument panel 320 embodying the principles of the present invention will now be discussed. The instrument panel 320 has a generally arcuate show surface 332 (shown in FIG. 8), whereas the instrument panels discussed in conjunction with FIGS. 1-5 have a generally planar show surface.

The method of assembling the instrument panel 320 depicted in FIGS. 6-8 generally includes the following steps: coupling the skin 324 and the added article 330 with each other in a vacuum mold assembly 370 (FIGS. 6 and 7), forming a substrate 322, and coupling the skin/added article with the substrate 322 and a foam material 328 in an injection molding assembly 380 (FIG. 8).

First, as shown in FIGS. 6 and 7, the skin 324 and the added article 330 are coupled with each to form a surface component 366. More specifically, the surface component 366 is formed by inserting the added article 330 into a vacuum mold chamber 362, aligning the skin 324 with the vacuum mold chamber 362, and applying a vacuum force 364 (FIG. 6) to the vacuum mold chamber 362 so that the skin 324 substantially envelopes and mechanically engages the added article 330 and so that the skin 324 and the added article cooperate to define the show surface 332 (FIGS. 7 and 8) that is substantially uninterrupted along a transition area 338 between the skin 324 and the added article 330.

The added article 330 is preferably inserted into the vacuum mold chamber 362 so that the added article A-surface 334 completely engages the visible surface 368 of the vacuum mold chamber 362.

The skin 324, which is preferably made of a soft-feel, pliable material such as a vinyl compound, a polyvinyl chloride compound, or a thermoplastic polyolefin, is preferably formed by a process commonly known in the art, such as thermoforming or casting. The skin 324 is aligned with the vacuum mold chamber 362 by being extended across a top opening 372 of the vacuum mold chamber 362. More specifically, the vacuum mold chamber 362 is defined by the vacuum mold surface 368 of the vacuum mold assembly 370 and a lower surface 376 of the skin 324. In the figures, the vacuum mold surface 368 is generally concave in shape, but any suitable shape may be used. Preferably, only a portion of the skin 324 is extended across the top opening 372 so that a portion 378 of the skin 324 is able to be secured via conventional methods over the top surface 375 of the vacuum mold assembly 370, thereby improving the form-fitting engagement between the skin 324 and the added article 330. Alternatively, the skin 324 may be aligned with the vacuum mold chamber 362 by being inserted, or partially inserted, within the vacuum mold chamber 362.

Next, a vacuum force 364 is applied to the vacuum mold chamber 362, the skin 324 is pulled into the vacuum mold chamber 362 and into engagement with vacuum mold surface 368 and the B-surface 336 of the added article 330. The vacuum force 364 is preferably generated by a vacuum source (not shown) or another suitable device that is in fluid communication with the vacuum mold chamber 362 via a vacuum conduit 378 extending through the vacuum mold assembly 370. Alternatively, the vacuum mold assembly 370 may be partially or completely made of a porous material so that air is able to exit the mold and avoid becoming trapped between the skin 324 and the vacuum mold surface 368.

The portion 378 of the skin 324 that is retained at the top surface 375 of the vacuum mold assembly 370 prevents the entire skin 324 from being pulled into the vacuum mold chamber 362, thereby causing the skin 324 to stretch or deform into a form-fitting engagement with the relatively large area of the vacuum mold surface 368. The stretching action of the skin 324 improves the form-fitting engagement between the skin 324 and the added article 330 and causes the respective components 324, 330 to be more securely connected to each other. As mentioned herein, the form-fitting engagement between the skin 324 and the added article 330 is more secure if the skin 324 is heated first, due to improved plasticity of the skin 324 upon heating.

As mentioned above, the skin 324 is preferably heated before the application of the vacuum force 364. The heating operation improves the stretchability and the moldability of the skin 324. Furthermore, the heating step may be used to activate or increase an adhesive quality of the skin 324. Alternatively, an additional heating step may be used to activate or increase an adhesive quality of the skin 324 or another component. The heating operation is preferably performed with a heating lamp or another appropriate device, such as an infra red heating element or an oven.

The substrate 322, which is preferably made of a hard-setting, moldable material such as polypropylene, is preferably injection molded into a first molding device as is commonly known in the art. Referring now to FIG. 8, to form the instrument panel 20, the substrate 322 is placed in an upper portion 380a of the injection molding assembly 380 and the negative vacuum formed surface component 366 (the skin 324 with the added article 330) is placed in engagement with a lower portion 380b of the injection molding assembly 380 so that the respective components 322, 366 cooperate to define a cavity 326. The upper and lower portions 380a, 380b preferably have respective surfaces that engage the respective surfaces of the substrate 322 and the surface component 366 in a mating engagement. Next, the foam material 328 is injected into the foam mold assembly through one or more injection ports 382 extending through the substrate 322. Additionally, to further promote complete distribution of the foam material 328 throughout the cavity 326, one or more vacuum ports (not shown) may also extend through the substrate 322 to permit air to escape the cavity 326.

Referring to FIGS. 9 and 10, the method of assembly may additionally include the step of securing the added article to a mold surface of the vacuum mold chamber. For example, as shown in FIG. 9, the added article 430 may be releasably secured to the mold surface 468 with a magnetic force 484. More specifically, the added article 430 and the mold surface 468 alternatively include a ferrous metal and/or a magnetic portion so that they are magnetically attracted to each other. The added article 430 is then releasable from the mold surface 468 by applying a force in the opposite direction of the magnetic force 484, pulling, or by discontinuing the magnetic force (such as in the case of an electro-magnetic device).

As another example, shown in FIG. 10, the added article 530 may be releasably secured to the mold surface 568 with a suction force 586 that may be other than the vacuum force applied to the vacuum mold chamber through the vacuum conduit 578. Alternatively, as mentioned herein, the suction force 586 may be applied through a generally porous portion of the mold. More specifically, a second vacuum conduit 588 extends through the vacuum mold assembly 570 so as to be able to apply the suction force 586 to the added article 530 until the skin is in the form-fitting engagement therewith. Once the added article 530 is secured by the skin, the suction force 586 is discontinued.

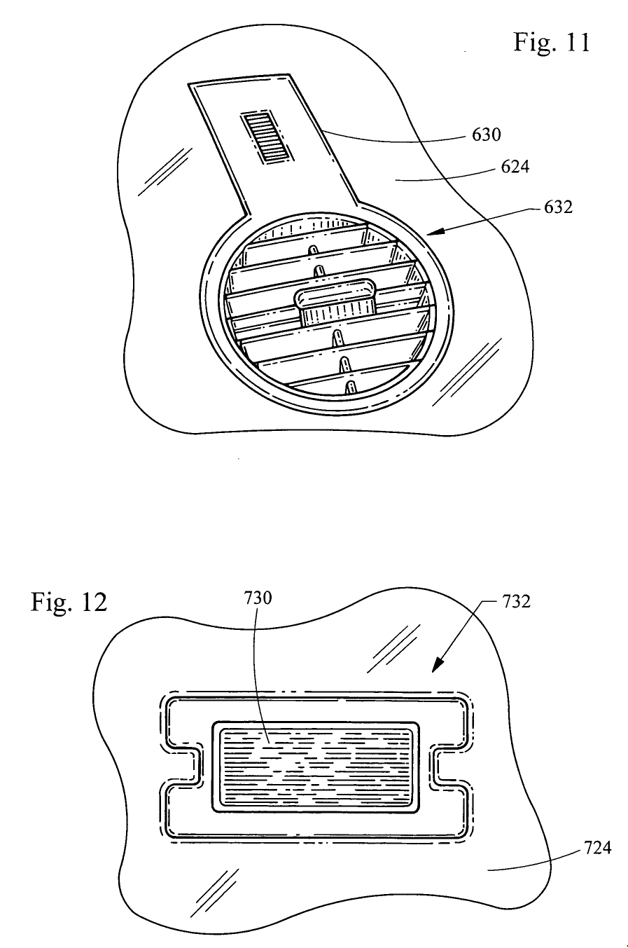

As mentioned above, the added article may have primarily functional applications in addition to or instead of decorative functions described above. For example, as shown in FIG. 11, an added article in the form of a trim portion 630 for a HVAC vent is supported by a skin 624 and cooperates therewith to define a show surface 632. In this configuration, some of the skin 624 will need to be cut, trimmed, or otherwise removed from the B-side of the trim portion 630 so that air is able to flow therethrough. As with the embodiments discussed above, the show surface 632 is substantially uninterrupted along a boundary between the HVAC vent 630 and the skin 624.

As another example, FIG. 12 shows an added article in the form of a depressible light element 730 that is supported by a skin 724 and that cooperates therewith to define a show surface 732. In this configuration, a portion of the light element 730 is configured to be moveable with respect to the skin 724 upon application of an external force, so as to turn the light element 730 “on” and “off”.

The added article 30 may be generally rigid or generally non-rigid, depending on the desired design parameters of the instrument panel. In the case of a non-rigid article, the width and thickness thereof can be larger than the preferred parameters described above without creating an undesirably large gap or off-set distance.

The present invention permits the use of an added mold component that can be used to temporarily change the surface without having to permanently change the mold and without incurring retooling costs. For example, a mold component may be secured to the mold via a magnetic force, or mechanical connection (such as pins, screws, or a pair of indexing components that are matingly engaged with each other). More specifically, the mold component is coupled with the mold surface and the skin is vacuum formed over the mold component as described above with respect to the added article and the skin. Then, the skin is removed from the mold, while mold component remains in the mold, and the skin is coupled with a substrate by injecting a foam material there between. The finished component has a depression or another shape formed in the outer surface of the skin from interaction with the mold component.

Additionally, the present invention may be utilized in conjunction with vehicle interior components other than an instrument panel. Moreover, the present invention is not intended to be limited to automotive applications or to other types of vehicles. For example, the present invention may be utilized with any application having a skin and an added article.

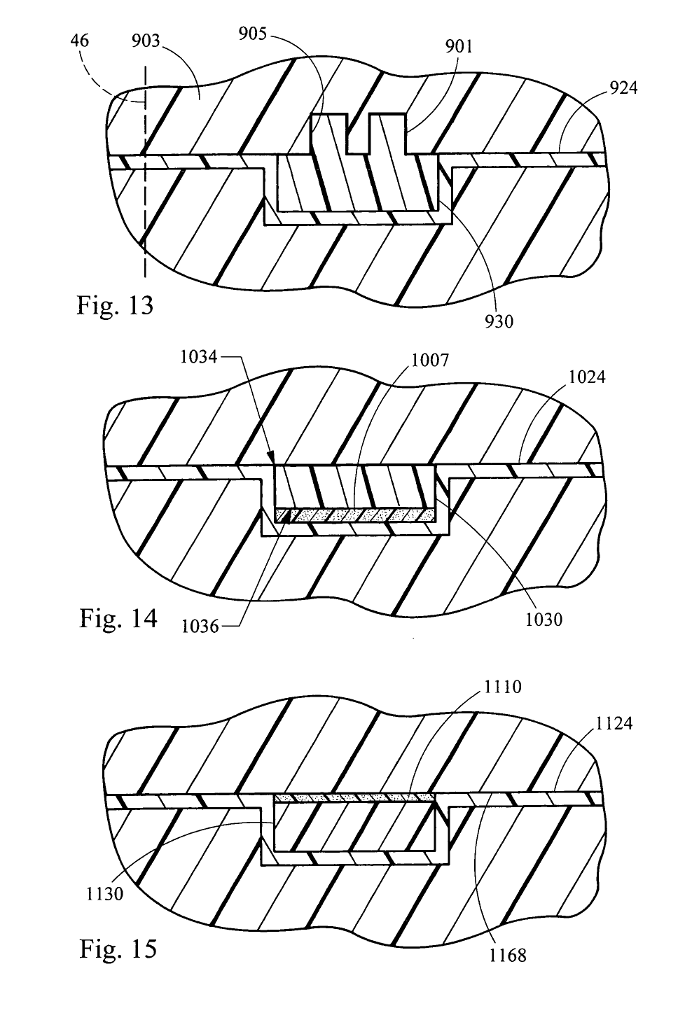

FIG. 13 shows an alternative embodiment of the present invention where the added article 930 extends beyond the skin 924 along the direction 46 so that the respective components 924, 930 are not generally flush with each other. For example, the added article 930 includes protrusions 901 that are configured to be connection elements, such as snaps or bolts that extend beyond the skin 924 so that they may engage another component (not shown). As another example, the added article 930 may include a portion that protrudes from the skin 924 for aesthetic purposes, such as a generally arcuate protruding portion that is intended to add contour to the overall appearance of the vehicle interior.

The embodiment shown in FIG. 13 includes a mold 903 having a pair of depressions 905 for receiving the protrusions 901. More specifically, the depressions 905 are configured to receive protrusions 901 in a mating engagement so the transition area between the skin 924 and the added article 930 is substantially uninterrupted. The depressions 905 may also provide an improved means of properly positioning the added article 930 in the desired position within the mold 903. Furthermore, the depressions 905 may support the added article 930 during the assembly of the component.

FIG. 14 shows another alternative embodiment of the present invention, where an intermediate layer 1007 is positioned between the added article 1030 and the skin 1024 to minimize air pockets along the A-surface 1034 of the skin 1024 and the added article 1030. The intermediate layer 1007 is positioned along the B-surface 1036 of the added article 1030 so that air trapped between the added article 1030 and the skin 1024 is able to permeate the intermediate layer 1007 and minimize or prevent the formation of air pockets adjacent to the A-surface 1034. More specifically, the intermediate layer 1007 is positioned away from the A-surface so that air pockets are less likely to form near the A-surface 1034. The intermediate layer is preferably made of an air-porous material, such as foam or a fiber structure.

FIG. 15 shows yet another alternative embodiment of the present invention, where the method of assembly includes the step of positioning a protective layer 1110 between added article 1130 and the vacuum mold surface 1168 to protect at least one of the respective components 1130, 1168. The protective layer 1110 may be a generally porous material so that air is less likely to be trapped between the added article 1130 and the vacuum mold surface 1168. Additionally, the porous nature of the protective layer 1110 may also improve the protection of the respective components 1130, 1168. However, the protective layer 1110 may be made of any appropriate material, such as foam or a woven or non-woven fiber structure. The thickness of this protective layer 1110 is preferably less than 1.0 millimeter.

The protective layer 1110 may be temporarily fixed to the vacuum mold surface 1168 by any suitable means, such as an adhesive, a magnetic force, or a vacuum force holding the protective layer 1110 between the respective components 1110, 1168. After the skin 1124 and the added article 1130 are coupled with each other and removed from the vacuum mold surface 1168, the protective layer 1110 is preferably removed from the added article 1130. The vacuum mold surface 1168 may include an indentation configured to receive the protective layer 1110 in a mating engagement so that the added element 1130 is flush with the skin 1124.

In another alternative design, the added article may be removable from the skin after assembly of the component. For example, the added article may be coupled with the skin via a slideable engagement or via a snap-fit engagement. More specifically, the added article may be a writing utensil that is removable from engagement with the instrument panel.

In yet another alternative design, the added article may include an electronic feature, such as a display screen or a light element. In this design, the added element is electrically connected with a control assembly via a mechanical connection or a wireless connection.

It is therefore intended that the foregoing detailed description be regarded as illustrative rather than limiting, and that it be understood that it is the following claims, including all equivalents, that are intended to define the spirit and scope of this invention.

What is claimed is:

1. A method of assembling a component for an interior of a vehicle comprising:
positioning an added article on a visible surface of a vacuum mold;
aligning a skin above the vacuum mold;
applying a vacuum force via the vacuum mold;
drawing the skin into engagement with the visible surface of the vacuum mold; and
enveloping a substantial portion of the added article with the skin so that the skin retains the added article therewith and the skin and the added article cooperate to define a show surface that is substantially uninterrupted along a transition area between the skin and the added article.

2. A method as in claim 1, wherein the vacuum force is applied so that the show surface is interrupted by a gap at the transition area of less than or equal to 1 millimeters.

3. A method as in claim 1, wherein the vacuum force is applied so that the show surface is interrupted by a gap at the transition area of less than or equal to 0.1 millimeters.

4. A method as in claim 3, wherein the show surface is interrupted by the gap at the transition area of less than or equal to 0.05 millimeters.

5. A method as in claim 1, further comprising the step of providing an adhesive between at least a portion of the added article and the skin.

6. A method as in claim 1, further comprising the step of heating the skin before applying the vacuum force.

7. A method as in claim 1, further comprising the step of securing the added article to the visible mold surface with a magnetic force.

8. A method as in claim 7, wherein the step of securing the added article to the mold surface of the vacuum mold includes releasably securing the added article to the mold surface with a magnetic force.

9. A method as in claim 1, further comprising the step of securing the added article to the visible mold surface with a suction force.

10. A method as in claim 9, wherein the suction force is provided by means other than the vacuum force applied to the vacuum mold.

11. A method as in claim 1, further comprising the step of positioning the added article within a depression in the visible surface of the vacuum mold to secure the added article with respect to the visible surface of the vacuum mold.

12. A method as in claim 1, further comprising the step of providing a protective layer between the added article and the visible surface of the vacuum mold to protect at least one of the vacuum mold and the added article.

13. A method as in claim 12, wherein the step of providing the protective layer includes providing a generally porous layer so that air is able to penetrate the protective layer and minimize any interruptions between the added article and the skin.

14. A method as in claim 1, further comprising the step of positioning a generally porous layer between the added article and the skin so that air trapped between the added article and the skin is able to penetrate the porous layer.

15. A method as in claim 1, further comprising:
removing the skin retaining the added article from the vacuum mold;
coupling the skin retaining the added article with a substrate by locating a foam material therebetween.

16. A method of assembling a component comprising:
providing an added article having an A-surface and a B-surface that cooperate to completely define an exterior surface of the added article;
inserting the added article into a vacuum mold so that the A-surface of the added article engages a visible surface of the vacuum mold; and
drawing via a vacuum force a skin into engagement with the visible surface and substantially completely enveloping the B-surface of the added article so that the skin and the A-surface of the added article cooperate to define a show surface that is substantially uninterrupted along a transition area between the skin and the added article.

17. A method as in claim 16, wherein the step of drawing the skin into engagement with the visible surface includes applying the vacuum force at a magnitude so that the show surface is interrupted by a gap less than or equal to 0.1 millimeters.

18. A component for an interior of a vehicle comprising:
an added article having an A-surface and a B-surface cooperating to completely define a surface area of the added article;
a skin substantially completely enveloping the B-surface of the added article to mechanically engage and retain the added article therewith, the skin cooperating with the A-portion of the added article to define a show surface that is substantially uninterrupted along a transition area between the skin and the added article.

19. A component as in claim 18, wherein the transition area is substantially interrupted and has a gap less than or equal to 1.0 millimeters between the skin and the added article.

20. A component as in claim 19, wherein the gap is less than or equal to 0.1 millimeters.

21. A component as in claim 20, wherein the gap is less than or equal to 0.05 millimeters.

22. A component as in claim 18, wherein the skin and the added article are generally flush with each other along the transition area.

23. A component as in claim 18, further comprising a generally porous layer positioned between at least a portion of the B-surface of the added article and the skin so that air trapped between the added article and the skin is able to penetrate the porous layer.

24. A component as in claim 16, further comprising an adhesive layer between at least a portion of the added article and the skin.
